(19) United States
(12) Patent Application Publication
(10) Pub. No.: US 2020/0206892 A1
(43) Pub. Date: Jul. 2, 2020

(54) ACCESSORY CASE

(71) Applicant: Hilti Aktiengesellschaft, Schaan (LI)

(72) Inventor: Kenth KARLSSON, Wasserburg (DE)

(21) Appl. No.: 16/624,719

(22) PCT Filed: Jun. 19, 2018
(86) PCT No.: PCT/EP2018/066238

§ 371 Date: Dec. 19, 2019

(30) Foreign Application Priority Data
Jun. 29, 2017 (EP) 17178565.2

(51) Int. Cl. B25H 3/02

(52) U.S. Cl. CPC B25H 3/022

(57) ABSTRACT

A system made up of a case and a first container and a second container, both being positionable in the case, each container including a first, second, third and fourth side wall and a bottom for forming an interior area open in a first direction. A first wall element is positioned between the first and second side walls, a second wall element is positioned between the second and third side walls, a third wall element is positioned between the third and fourth side walls, and a fourth wall element is positioned between the fourth and first side walls, each wall element including a first, second, third and fourth plane each, and the first plane being situated at a first angle to the second plane and the bottom, and the third plane being situated at a second angle to the second and fourth planes, so that the first and third planes are situated essentially in parallel to one another, and the second and fourth planes are situated essentially in parallel to one another, and the first angle and the second angle being selected so that the first and third planes are inclined with respect to the interior area of the container, so that an inner side of the fourth plane of a first container rests against an outer side of the first plane of a second container when the first container is positioned with the bottom over the interior area of the second container.

The present invention relates to a system made up of at least one case and at least one first container and one second container, both the first container and the second container being positionable in the case, each container including a first, second, third and fourth side wall and a bottom for forming an interior area open in a first direction.

### BACKGROUND

Cases in which individual containers, such as boxes, may be positioned are largely known from the prior art. Such cases are often used by craftsmen to store small parts, such as screws, wall dowels, washers and the like, in such containers. The use of multiple containers is advisable when a wide variety of small parts is to be stored separately from one another, and a certain orderliness is to be maintained inside the case.

One problem with the containers available in the market, however, is that the containers which are intended for the positioning inside a craftsperson's case do not offer a secure support when such containers are placed on top of one another for space-saving reasons.

### SUMMARY OF THE INVENTION

It is an object of the present invention to solve the above-described problem and, in particular, to provide a system made up of a case and multiple containers, the containers having a relatively secure and stable support when these are placed on top of one another.

The present invention provides a system made up of at least one case and at least one first container and one second container, both the first container and the second container being positionable in the case, each container including a first, second, third and fourth side wall and a bottom for forming an interior area open in a first direction.

According to the present invention, a first wall is positioned between the first and second side walls, a second wall element is positioned between the second and third side walls, a third wall element is positioned between the third and fourth side walls, and a fourth wall element is positioned between the fourth and first side walls, each wall element including a first, second, third and fourth plane, the first plane being situated at a first angle to the second plane and the bottom, and the third plane being situated at a second angle to the second and fourth planes, so that the first and third planes are essentially situated in parallel to one another, and the second and fourth planes are situated essentially in parallel to one another, and the first and second angles being selected in such a way that the first and third planes are inclined with respect to the interior area of the container, so that an inner side of the fourth plane of a first container rests against an outer side of the first plane of a second container when the first container is positioned with the bottom over the interior area of the second container.

In this way, a first container may be placed on a second container in a secure and stable manner.

Further advantages are derived from the following description of the figures. The figures show different exemplary embodiments of the present invention. The figures, the description and the claims include numerous features in combination. Those skilled in the art will advantageously also consider the features individually and combine them into useful further combinations.

### BRIEF DESCRIPTION OF THE DRAWINGS

In the figures, identical and similar components are denoted by identical reference numerals.

FIG. 1 shows a perspective view of a system according to the present invention made up of a case including a number of containers;

FIG. 2 shows a perspective view onto a container according to a first specific embodiment including a first, second, third and fourth side wall and including a first, second, third and fourth wall element;

FIG. 3 shows a bottom view onto the container including the first and second side walls and the first wall element positioned therebetween;

FIG. 4 shows a further perspective view onto the container including the first and second side walls and the first wall element positioned therebetween;

FIG. 4a shows a sectional view along intersecting line A-A in FIG. 4;

FIG. 4b shows a sectional view along intersecting line A-A in FIG. 4 with a first container above a second container;

FIG. 5 shows a perspective view onto two containers positioned on top of one another according to a first specific embodiment with a detailed view;

FIG. 6 shows a perspective view onto a container according to a further specific embodiment;

FIG. 7 shows a perspective view onto two containers positioned on top of one another according to a second specific embodiment;

FIG. 8 shows a perspective view onto two containers positioned on top of one another according to the second specific embodiment; and

FIG. 9 shows a perspective view onto a further container according to a further specific embodiment.

### DETAILED DESCRIPTION

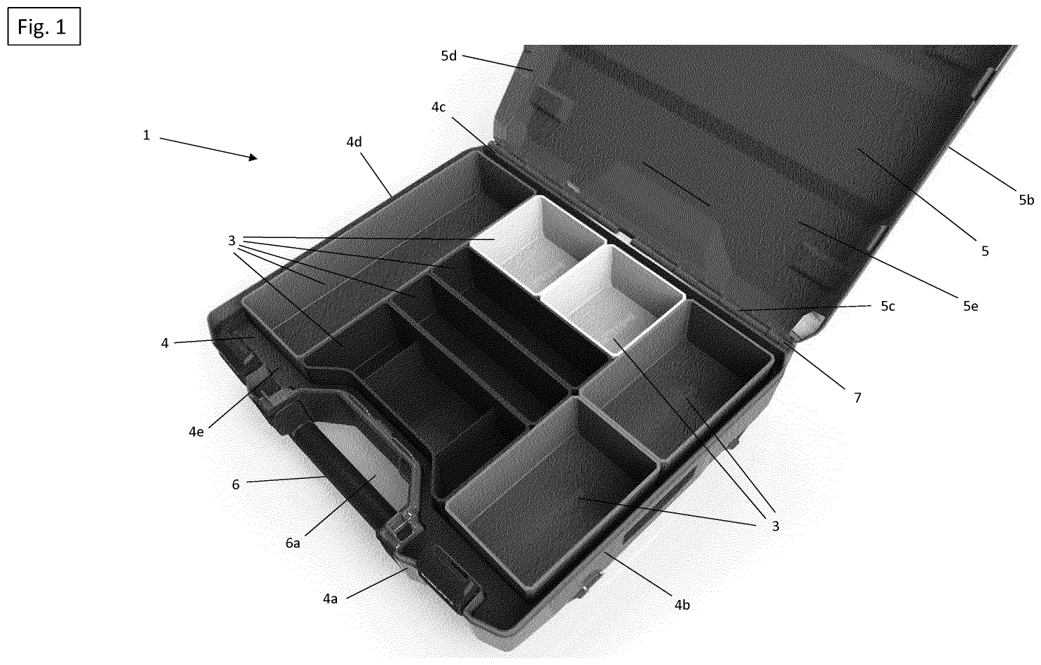

FIG. 1 shows a system 1 made up of a case 2 and eight differently designed containers 3. Containers 3 are positioned in the interior of case 2 in such a way that the side walls of containers 3 make contact with one another and thus do not form a clearance between containers 3. Containers 3 may be used, among other things, to accommodate small parts needed on a construction site, such as screws, dowels or the like. The small parts are not shown in the figures.

Case 1 is essentially made up of a bottom shell 4 and a top shell 5. Bottom shell 4 includes a first, second, third and fourth wall 4a, 4b, 4c, 4d and a bottom 4e. A handle 6 is positioned on first wall 4a for carrying case 2. As is apparent from the figure, bottom shell 4 includes a handle area 6a on which handle 6 is positioned. Handle area 6a is designed as a recess on bottom shell 4. Top shell 5 also includes a first wall and a second, third and fourth wall 5b, 5c, 5d and a cover 5e. Bottom shell 4 and top shell 5 may be moved relative to one another with the aid of a hinge 7, which is situated on third wall 4c of bottom shell 4 and on third wall 5c of top shell 5. In this way, in particular, top shell 5 may be positioned on bottom shell 4 to close case 2.

When case 2 is closed, containers 3 open toward the top are closed by top shell 5.

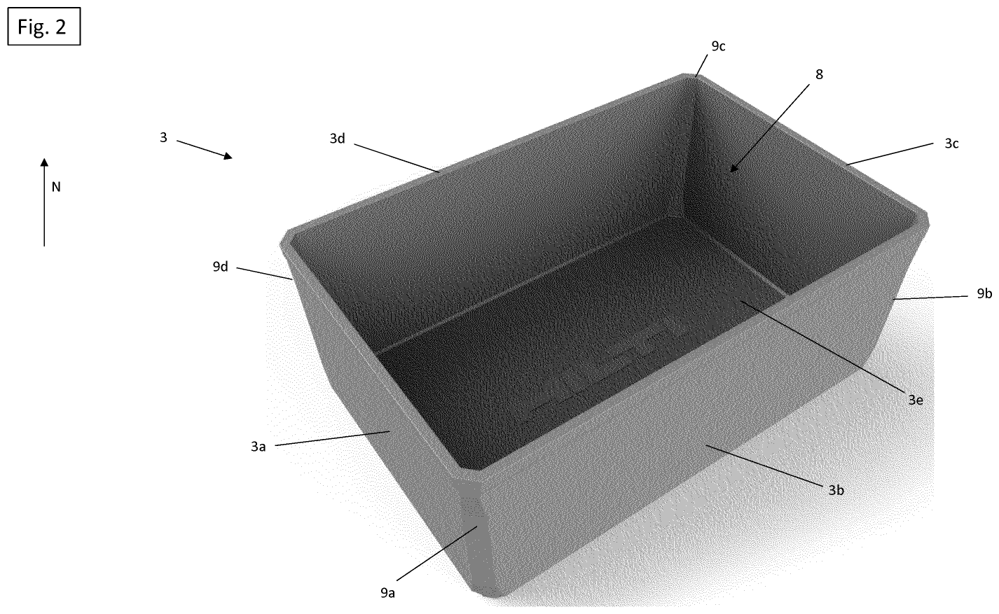

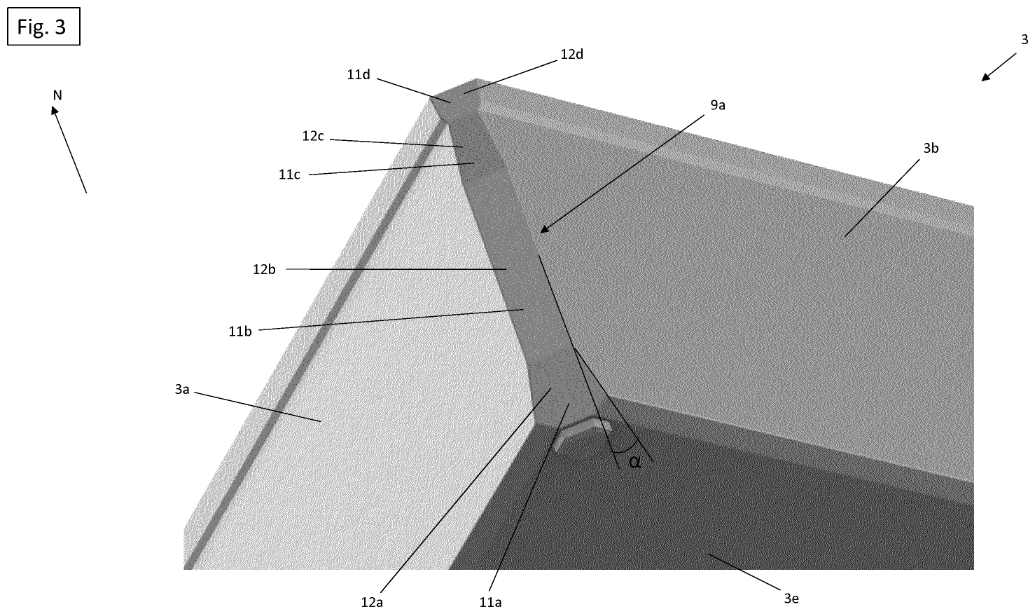

FIGS. 2 through 5 show a container 3 according to a first specific embodiment. However, it is also possible for container 3 to be designed corresponding to another specific embodiment. In FIG. 1, for example, container 3 is shown according to five different specific embodiments.

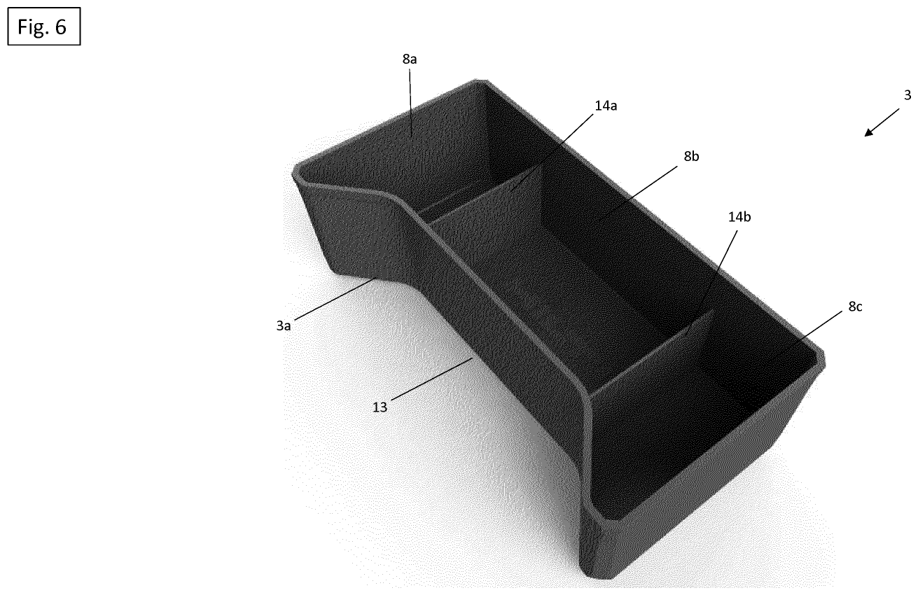

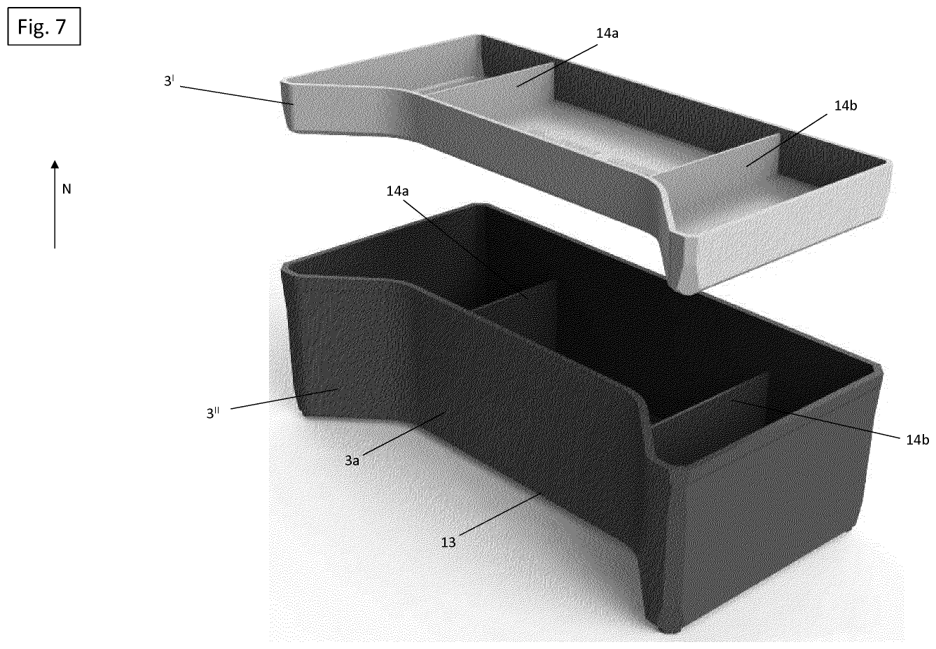

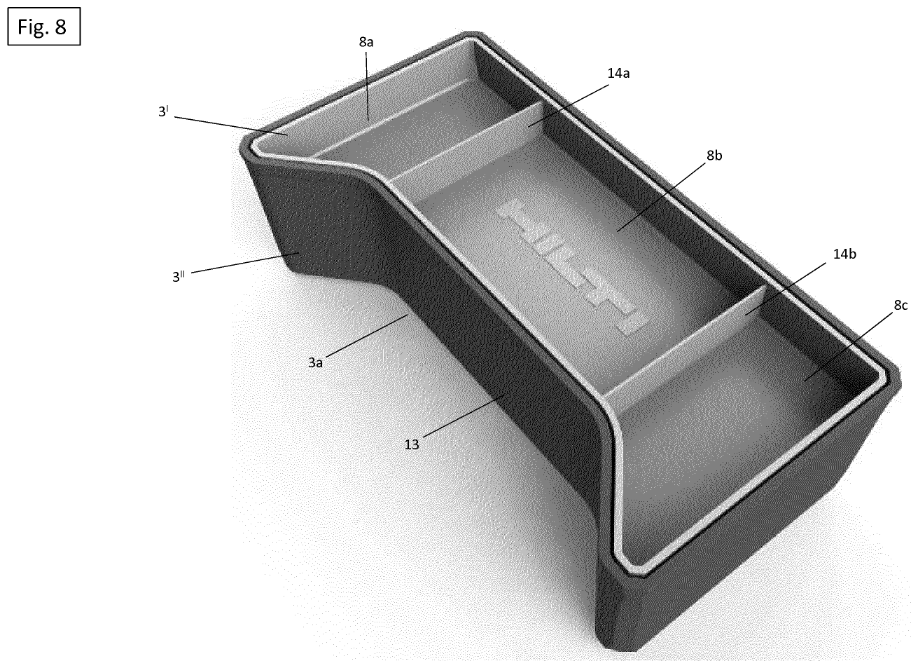

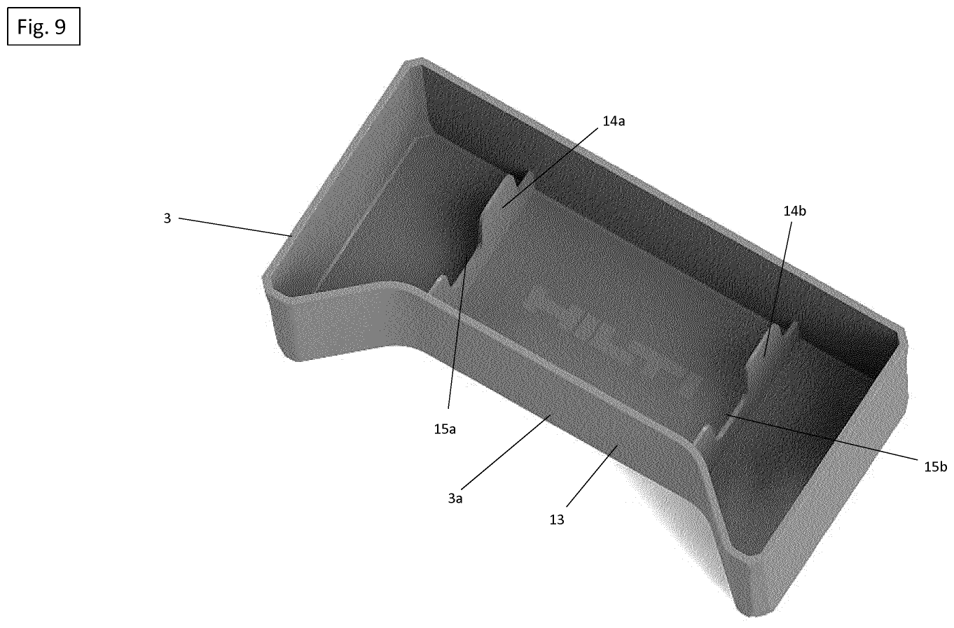

FIG. 6 furthermore shows a container 3 corresponding to a second specific embodiment. FIGS. 7 and 8 show a container 3 according to the second specific embodiment, and a container 3 according to a third specific embodiment. FIG. 9 shows a container 3 corresponding to a fourth specific embodiment.

As is shown in FIG. 2, a container 3 includes a first, second, third and fourth side wall 3a, 3b, 3c, 3d and a bottom 3e. Four side walls 3a, 3b, 3c, 3d and bottom 3e form a shell-like receptacle having an interior area 8, which is open toward a first direction N.

Furthermore, a first wall element 9a is positioned between first side wall 3a and second side wall 3b, a second wall element 9b is positioned between second side wall 3b and third side wall 3c, a third wall element 9c is positioned between third side wall 3c and fourth side wall 3d, and a fourth wall element 9d is positioned between fourth side wall 3d and first side wall 3a.

Each wall element 9a, 9b, 9c, 9d includes an inner side 10a, 10b, 10c, 10d and an outer side 11a, 11b, 11c, 11d each.

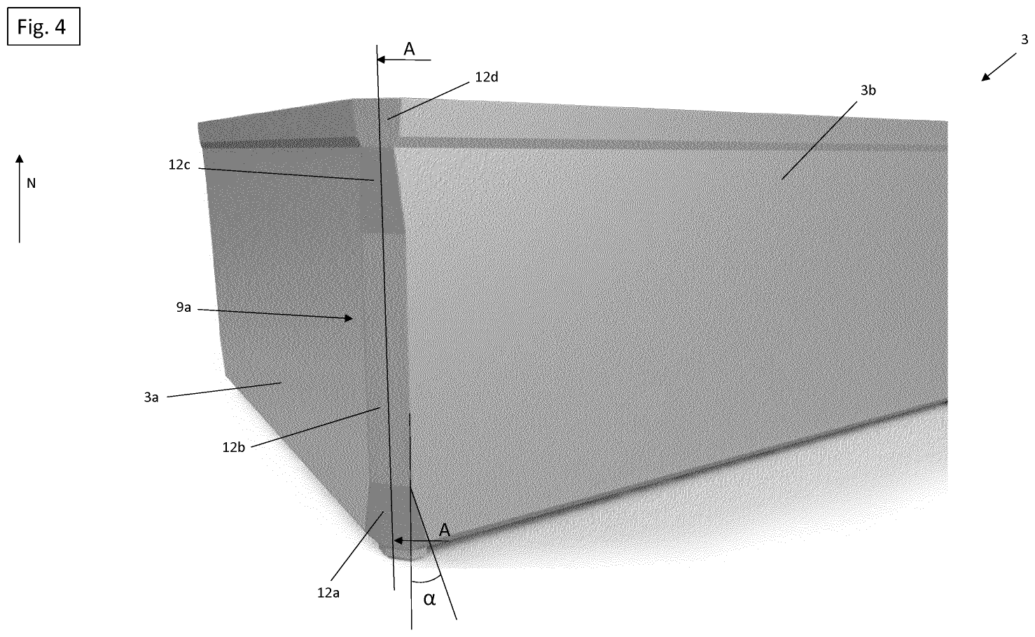

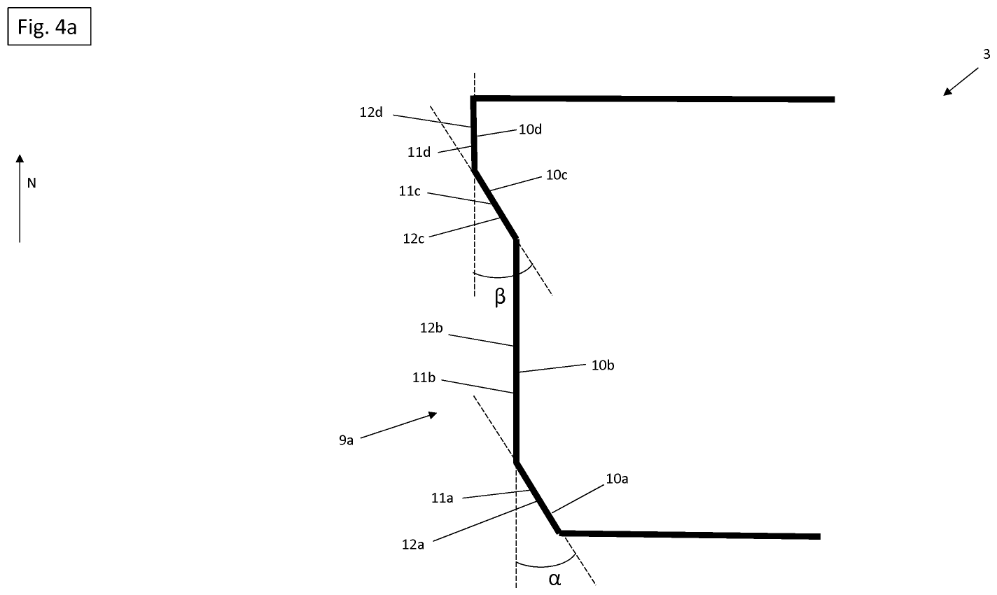

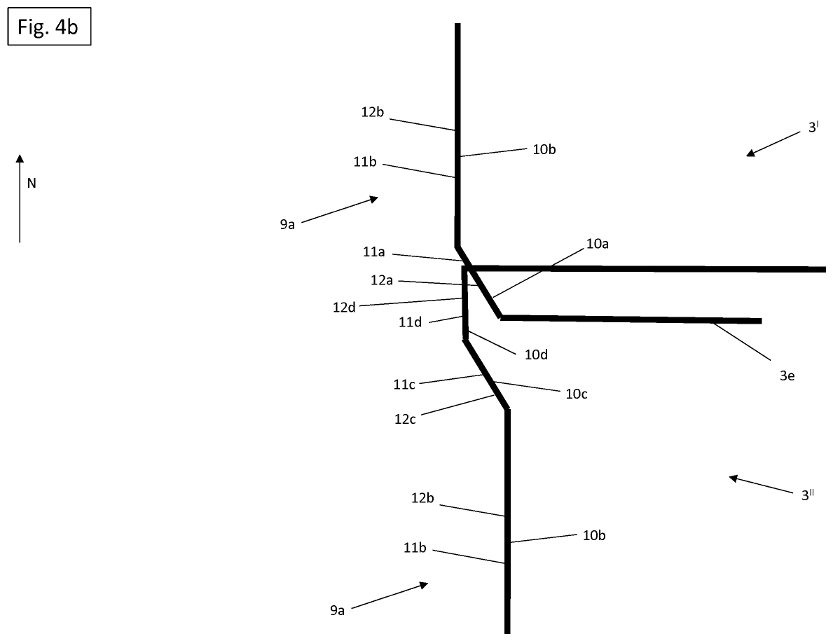

In addition, each wall element 9a, 9b, 9c, 9d includes a first, second, third and fourth plane 12a, 12b, 12c, 12d each. As is shown, in particular, in FIG. 4a (i.e., cross section along intersecting line A-A in FIG. 4), first plane 12a is situated at a first angle α to second plane 12b and bottom 3e. Third plane 12c is situated at a second angle β to second and fourth planes 12b, 12d, so that first and third planes 12a, 12c are situated essentially in parallel to one another, and second and fourth planes 12b, 12d are situated essentially in parallel to one another.

First plane 12a thus includes an inner side 10a and an outer side 11a. Second plane 12b includes an inner side 10b and an outer side 11b. Third plane 12c includes an inner side 10c and an outer side 11c. Fourth plane 12d includes an inner side 10d and an outer side 11d.

In the shown exemplary embodiment, the value of first angle α is 25°, and the value of the second angle is also 25°.

According to another specific embodiment, first and second angles α, β may also have different values. It is possible, for example, for first angle α to have a smaller value than second angle β. Furthermore, it is also possible for second angle β to have a smaller value than first angle α.

The specific design of wall element 9a, 9b, 9c, 9d having four planes 12a, 12b, 12c, 12d is used to ensure that containers 3 may be placed on top of one another in a secure and stable manner. Placing containers 3 on top of one another serves to save space when containers 3 are not situated in case 2.

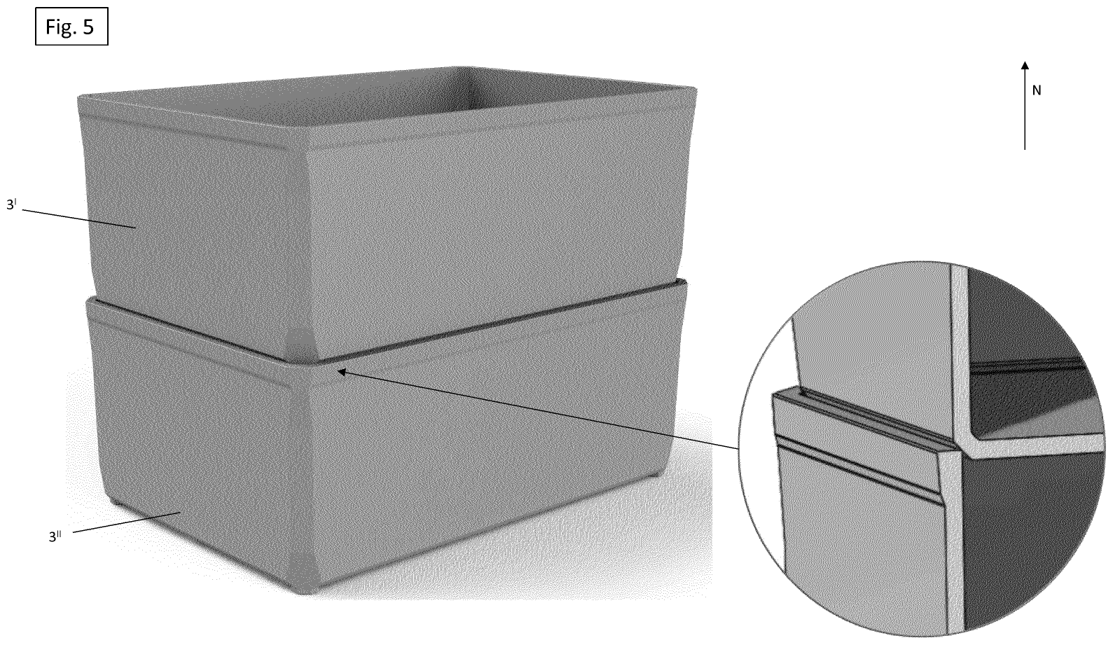

As is shown in FIGS. 4b and 5, a first container 3′ is positioned on a second container 3″. FIG. 4b shows a cross-sectional view similar to FIG. 4a. In contrast to FIG. 4a, a first container 3′ is positioned on a second container 3″ in FIG. 4b.

The example illustrated in FIG. 5 shows that the selection of first and second angles α, β is of significance, since inner side 10d of fourth plane 12d of second container 3″ rests against an outer side 11a of first plane 12a of a first container 3′ when second container 3″ is positioned with bottom 3e over an interior area 8 of second container 3″.

FIG. 6 shows a container 3 according to a second specific embodiment. This container 3 has a recess 13 on first side wall 3a, so that this container 3 may be positioned with recess 13 on handle area 6a of bottom shell 4 (cf. FIG. 1). Moreover, a first and a second partition 14a, 14b are present in interior area 8, which divide interior area 8 into a first, second and third area 8a, 8b, 8c.

FIGS. 7 and 8 again show a container 3 according to the second specific embodiment. A container 3 according to a third specific embodiment is shown above this container 3 (i.e., in the direction of arrow N). Container 3 of the third specific embodiment differs from the specific embodiment in that container 3 according to the third specific embodiment is flatter than the container of the second specific embodiment. In other words: height H of side walls 3a, 3b, 3c, 3d in the direction of arrow N is lower in the case of container 3 corresponding to a third specific embodiment than height H of side walls 3a, 3b, 3c, 3d in the direction of arrow N of container 3 according to the second specific embodiment.

FIG. 9 shows a container 3 according to a fourth specific embodiment. This container 3 essentially corresponds to container 3 of the second specific embodiment, however, again, first and second partitions 14a, 14b each have a first and second recess 15a, 15b to receive the temples of protective goggles. The protective goggles are not shown in the figures. A container 3 corresponding to the first through fourth specific embodiments may also be positioned on container 3 according to the fourth specific embodiment, i.e., in the direction of arrow N. Accordingly, a container 3 according to the fourth specific embodiment may also be positioned on a container 3 corresponding to the first through fourth specific embodiments, i.e., in the direction of arrow N.

1. (canceled)

2. A system comprising:
a case; and
a first container and a second container, both the first and the second container being positionable in the case, each of the first and second container including a first, second, third and fourth side wall and a bottom for forming an interior area open in a first direction,
each of the first and second container including a first wall element positioned between the first and second side walls, a second wall element positioned between the second and third side walls, a third wall element positioned between the third and fourth side walls, and a fourth wall element positioned between the fourth and first side walls, and each of the first, second, third and fourth wall elements each including a first, second, third and fourth plane;
the first plane being situated at a first angle to the second plane and the bottom, and the third plane being situated at a second angle to the second and fourth planes, so that the first and third planes are situated in parallel to one another, and the second and fourth planes are situated in parallel to one another, and the first angle and the second angle being selected in such a way that the first and third planes are inclined with respect to the interior area of the container, so that an inner side of the fourth plane of the first container rests against an outer side of the first plane of the second container when the first container is positioned with the bottom of the first container over the interior area of the second container.
